(19) United States
(12) Patent Application Publication
(10) Pub. No.: US 2017/0052799 A1
(43) Pub. Date: Feb. 23, 2017

(54) Integrated Circuit Device With Selectable Processor Core

(71) Applicant: Microchip Technology Incorporated, Chandler, AZ (US)

(72) Inventor: Sean Steedman, Phoenix, AZ (US)

(73) Assignee: Microchip Technology Incorporated, Chandler, AZ (US)

(21) Appl. No.: 15/241,851

(22) Filed: Aug. 19, 2016

Related U.S. Application Data
(60) Provisional application No. 62/208,090, filed on Aug. 21, 2015.

(51) Int. Cl. G06F 9/445; G06F 13/40

(52) U.S. Cl. CPC G06F 9/44505; G06F 13/4022

(57) ABSTRACT

An integrated circuit device includes a first processing core operable to process a first instruction set, a second processing core operable to process a second instruction set different from the first instruction set, a plurality of peripheral devices, a memory and a switching circuit configured to couple the memory and the plurality of peripheral devices with either the first processing core or the second processing core depending on a configuration setting of the integrated circuit device.

### CROSS-REFERENCE TO RELATED APPLICATIONS

This application claims priority to commonly owned U.S. Provisional Patent Application No. 62/208,090 filed Aug. 21, 2015, which is hereby incorporated by reference herein for all purposes.

### TECHNICAL FIELD

The present disclosure relates to integrated circuit devices with a processor core, and, in particular, microcontrollers.

### BACKGROUND

A microcontroller includes an integrated circuit device that comprises a central processing unit (CPU), also called processor core, memory, input/output ports, and a plurality of peripheral devices. These devices, thus, form a complete system that requires hardly any external component. In time sensitive applications an external crystal may be used together with an integrated oscillator for a system clock generation. However, less sensitive application may not need such a component and can rely on a fully integrated RC oscillator that may provide a high system clock by means of an integrated PLL circuitry.

### SUMMARY

Embodiments of the present disclosure include an integrated circuit device. The device includes at least two processing cores each operable to process different instruction sets, peripheral devices, a memory, and a switching circuit to couple the memory and the peripheral devices with either of the cores depending on a configuration setting of the integrated circuit device.

Embodiments of the present disclosure include at least one non-transitory computer-readable medium that include instructions. The instructions, when loaded and executed by an integrated circuit device, cause the integrated circuit device to process different instruction sets using two respective processing cores, and selectively couple a memory and peripheral devices with either of the cores depending on a configuration setting of the integrated circuit device.

Embodiments of the present disclosure include a method. The method includes processing different instruction sets using two respective processing cores, and selectively coupling a memory and peripheral devices with either of the cores depending on a configuration setting of the integrated circuit device.

### BRIEF DESCRIPTION OF THE DRAWINGS

FIG. 1 illustrates an example embodiment of a system for implementing a device with a selectable processor core;

FIG. 2 illustrates an example embodiment of a system for generating code for a device with a selectable processor core;

FIG. 3 illustrates an example embodiment of a system for creating an electronic device using a selectable processor core; and

FIG. 4 illustrates a block diagram of an example embodiment of a method for selecting a processor core on a device.

### DETAILED DESCRIPTION

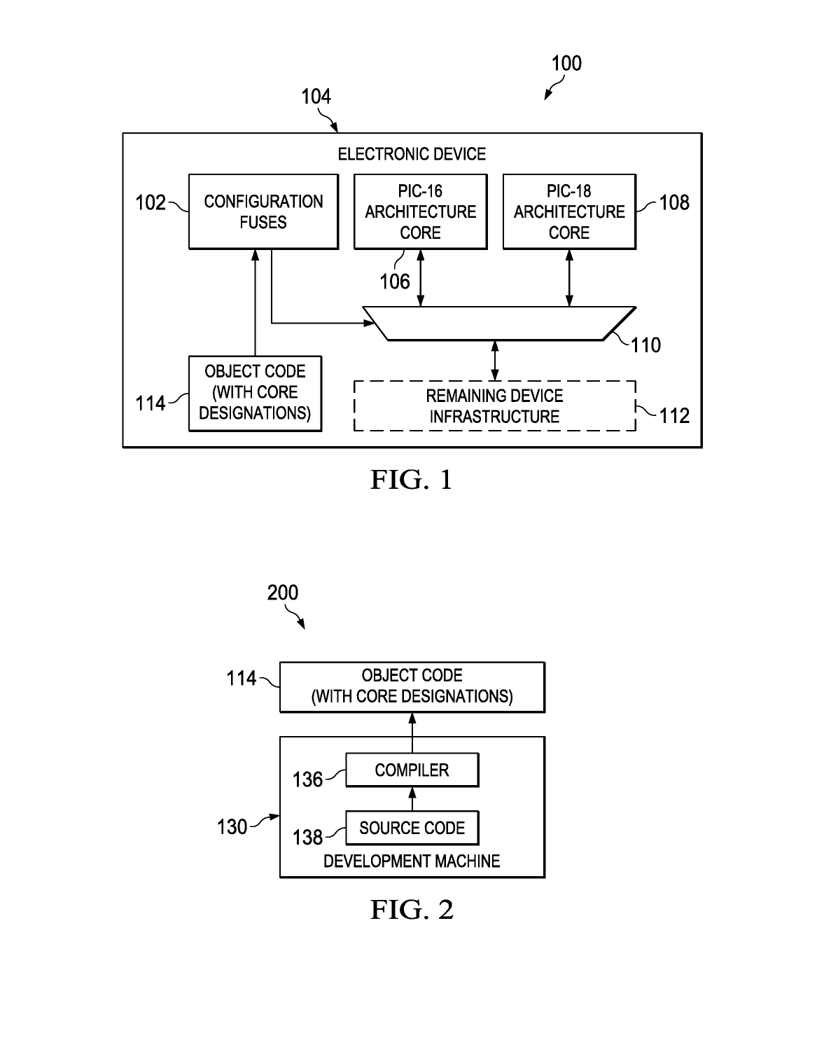

FIG. 1 is an illustration of an example embodiment of a system 100 for implementing an apparatus with a selectable processor core. In one embodiment, such a device may include an integrated circuit device. Such a device may include, for example, a microcontroller. The device may include multiple processor cores. Moreover, use of one or more cores may be mutually exclusive with one or more other cores. The use of a particular core or cores, over other cores, may be selected by software that is to be executed in system 100. The selection of the cores to be used for execution by code may be based upon, for example, different available architectures of different cores in system 100.

In the example of FIG. 1, the device may be implemented by electronic device 104. Electronic device 104 may include a processor, microcontroller, field programmable gate array, application-specific integrated circuit, or any suitable integrated circuit device. Electronic device 104 may include two or more processing cores or CPUs. For example, electronic device 104 may include a core 106 and a core 108. In one embodiment, cores 106, 108 may be implemented with different architectures. The difference in architectures may be manifest in, for example, a different size of processing bytes or bits, different instruction sets, or other mechanisms. In a further embodiment, code to be executed on one such architecture might be incompatible with the other architecture. Accordingly, object code 114 to be executed on electronic device 104 might be executable on one of cores 106, 108 but not the other of cores 106, 108. Although two kinds of cores are shown as examples in FIG. 1, electronic device 104 may include any suitable number of different kinds of cores. Furthermore, although a single core of the two different kinds of architecture are shown in FIG. 1, electronic device 104 may include multiple instances of each of cores 106, 108. In one embodiment, core 106 may be implemented with a PIC-16 architecture from Microchip Technology. In another embodiment, core 108 may be implemented with a PIC-18 architecture from Microchip Technology.

The space occupied by cores 106, 108 may be relatively small in size compared to other mechanisms for electronic device 104 to operate, such as remaining device infrastructure 112, which may contain busses, memory, registers, input and output ports, caches, interfaces, peripherals, etc. For example, cores 106, 108 may constitute only 1-2% of the total die size for electronic device 104. Accordingly, multiple cores may be placed in electronic device 104 without significantly impacting available space. Each different architecture of a core may also require additional elements, such as on-die peripherals, interfaces, etc., which may require additional die space. However, some portions of infrastructure might be reused by different kinds of cores. For example, there may be considerable overlap in infrastructure between PIC-16 and PIC-18 architectures. The number of different kinds of architectures for cores which might be implemented on electronic device 104 may be limited by the space available on the die given the additional requirements of space for cores and associated interfaces and supporting infrastructure.

Software that is to be executed by electronic device 104 may include object code 114. In one embodiment, based upon object code 114, electronic device 104 may selectively execute object code 114 on core 106 or core 108. In another embodiment, such a selection between core 106 and core 108 may be mutually exclusive. Determining which of cores 106, 108 will execute object code 114 may be performed in any suitable manner. For example, electronic device 104 may identify a type of architecture on which object code 114 is to be executed. Such a type of architecture may be specified explicitly or implicitly. In one embodiment, when object code 114 is created, it may include a designation of the type of core or architecture on which it is to be executed. This designation may be embedded within, attached to, or implicitly specified in object code 114. The designation may be compiled, linked, or otherwise assigned to object code 114. The designation may be assigned at when the code is written, compiled, linked, or another suitable time. Drafters of object code 114 may select on which cores the code can be executed.

Electronic device 114 may read or determine the designations of the cores on which object code 114 can be executed. Subsequently, electronic device 114 may set such assignments using any suitable mechanisms. In one embodiment, electronic device 114 may set one or more configuration fuses 102 to specify which of the cores are to execute object code 114. Configuration fuses 102 may be implemented in any suitable manner, such as by die traces, pre-processor directives, configuration bits, physical or virtual jumpers, a physical metal link (that has been preserved during manufacturing to set the fuse, as opposed to selectively broken to un-set a fuse), a FLASH memory cell, or cross-coupled memory cell. The particular ones of configuration fuses 102 that are to be used may be specified by object code 114 or may be interpreted from object code 114 by electronic device 102. Configuration fuses 102 may be set or read at any suitable time, such as load time, power-up, or any other suitable time prior to the execution of object code 114. Configuration fuses 102 may be set by, for example, preserving a metal trace or writing data to a memory cell. A configuration fuse might be cleared by breaking a metal trace during manufacturing, leaving only configuration fuses 102 intact that are to represent set fuses. Configuration fuses 102 may cause a multiplexer, switch, circuitry, or selector 110 to engage the correct core to execute object code 114 with remaining device infrastructure 112. In one embodiment, no external configuration pin might be needed to program the core that is selected to execute object code 114. In another embodiment, an external configuration pin might be used in conjunction with configuration fuses 102 to select which core will execute object code 114. For example, an external configuration pin might specify a binary value or bit-code that translates into a selection of a given one of cores 106, 108.

Operation of electronic device 104 to load object code 114 and select appropriate cores through configuration fuses 102 may be performed in any suitable manner. In one embodiment, such operation may be performed through microcode, basic input-output systems, embedded code, or analog or digital circuitry. Instructions may be stored in a computer-readable memory that, when executed by a processor, cause the electronic device to perform the some or all of the operations described in this disclosure. The processor may be implemented by, for example, a field programmable gate array, application specific interface circuit, or other suitable mechanism. The memory may be non-transitory, read-only memory, random access memory, persistent memory, FLASH memory, or implemented in any other suitable manner.

Electronic device 104 may load object code 114 into a memory. Electronic device 104, after determining from configuration fuses 102 which of cores 106, 108 will execute object code 114, may operate switching circuitry in selector 110 to communicatively couple the memory that contains object code 114 to the appropriate one of cores 106, 108. Object code 114 may be then executed.

FIG. 2 illustrates an example embodiment of a system 200 for creating code for an electronic device that may select a core for executing code. FIG. 2 illustrates how a user may build code in a given architecture mode to target one of the architecture types of cores 106, 108. A user may use a development machine 130 implemented by any suitable computer, server, or other mechanism. In development machine 130, a compiler 136 (or linker, interpreter, or other suitable software program) may read source code 138 and generate object code 114 from the source code 138. Designations of the type of architecture or core in which object code 114 may be executed may be added to or included within object code 114. The designations may be made using libraries, functions, or other source code available to compiler 136. Compiler 136 may be implemented by instructions, functions, libraries, scripts, code, or other elements stored in one or more memories for execution by one or more processors. The instructions, when loaded and executed by processors, configure the compiler to perform the functionality described in this disclosure.

End users may select build code in any suitable architecture available for electronic device 104 and compare results to determine which architecture is better for their purposes. The steps of compiling code and selecting different architectures cores or types may be repeated as needed to evaluate the effects of executing source code 138 in different architectures or types of cores.

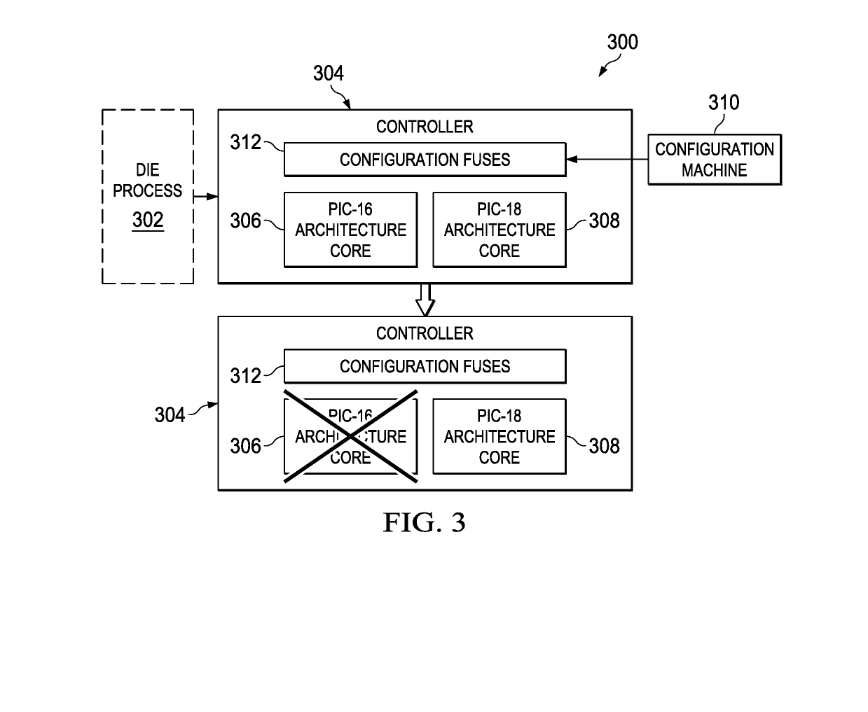

FIG. 3 is an illustration of an example embodiment of a system 300 for creating an electronic device using a selectable processor core

In one embodiment, a fabricator, maker, creator, or even end user of electronic device 104 may select which of cores 106, 108 are to be used to execute object code 114. In such an embodiment, the selection might be performed by burning or hard-wiring an internal fuse. Such a selection might be performed during a test procedure or manufacturing process. In a further embodiment, such a selection might be permanent. Accordingly, a manufacturing process for electronic device 104 might add both types of cores 106, 108, but the resulting electronic device might enable a single one of the types of cores 106, 108. Thus, the same manufacturing process might be used to build electronic devices of different architectures, wherein the process might select a personality or architecture type of electronic device 104 at such a burn process to hard-wire the configuration fuse 102 for a respective one of the types of cores 106, 108. A single base die might be used, for example, to manufacture both PIC-16 and PIC-18 architecture microcontrollers.

For example, in FIG. 3, a die process in manufacturing may yield a controller 304, which may implement fully or part of electronic device 104. In one embodiment, controller 304 may include configuration fuses 312. In another embodiment, controller 304 may have configuration fuses 312 added during the configuration process. Configuration fuses 312 may be implement configuration fuses 102. Furthermore, controller 304 may include two or more mutually exclusive cores 306, 308, which may implement cores 106, 108.

A configuration machine 310 may add, permanently, or semi-permanently set configuration fuses 312 for one of the mutually exclusive cores 106, 108 of controller 304. Configuration machine 310 may be located, for example, in manufacturing facilities producing controller 304 or at an end user site where controller 304 is received. Configuration machine 310 may burn traces, write data, or otherwise set configuration fuses 312 for a designated type of core or architecture. Subsequently, controller 304 might be configured to use the designated type of core or architecture to the exclusion of the other types of architecture or cores.

For example, configuration machine 310 may permanently hardwire configuration fuses 312 to characterize the operation of controller 304 as a PIC-18 architecture controller

Configuration machine 310 may be implemented by, for example, a server or computer. Configuration machine 310 may be implemented by instructions, functions, libraries, scripts, code, or other elements stored in one or more memories for execution by one or more processors. The instructions, when loaded and executed by processors, configure configuration machine 310 to perform the functionality described in this disclosure.

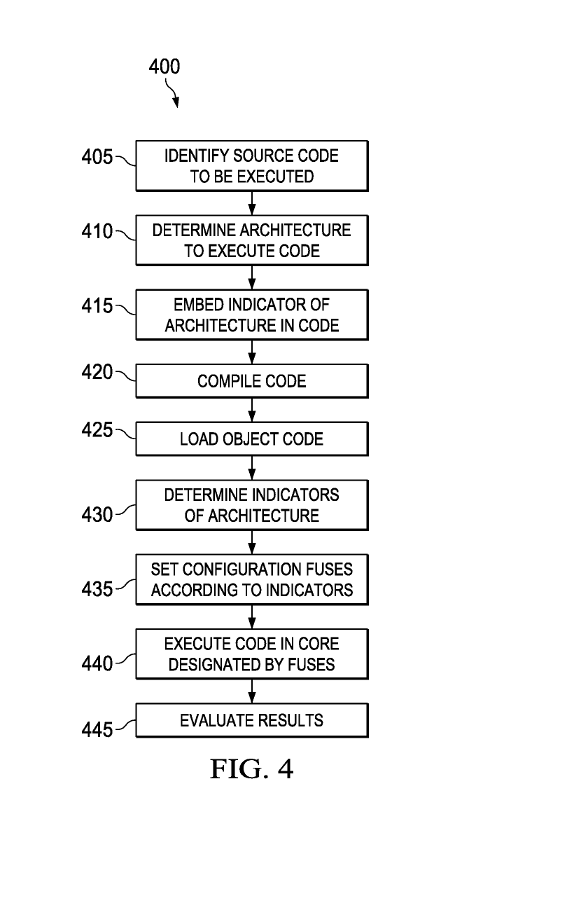

FIG. 4 is an illustration of an example embodiment of a method 400 for tracking the position of bodies. In one embodiment, method 400 may be implemented in software. Method 400 may be implemented by any suitable mechanism, such as systems 100, 200, or 300.

At 405, source code to be executed may be identified. At 410, an architecture or a type of processing core that is to execute the source code may be identified. At 415, an indicator of the architecture may be embedded, indicated, or attached to the source code or to compiled code. At 420, the source code may be compiled. Steps 415 and 420 may be executed in any order.

At 425, compiled object code may be loaded on to an electronic device that is to execute the code. At 430, any indicators of architecture, such as indicators in the source code, hardwired fuses, or external pins may be accessed. At 435, switch circuitry, configuration fuses, or other suitable mechanisms may be set according to the indicators of architecture, if necessary. At 440, the code may be executed in the core or types of cores identified in the indicators of architecture.

At 445, the results of execution may be determined. Method 400 may optionally repeat using a different architecture.

Although an example order of steps is shown, the steps of the methods discussed above may be performed in any order. Moreover, one or more steps may be optionally repeated, performed in parallel, or omitted. Method 400 may be performed multiple times. The methods may be performed beginning at any suitable initialization point.

Although example embodiments have been described above, other variations and embodiments may be made from this disclosure without departing from the spirit and scope of these embodiments.

1. An integrated circuit device comprising:
a first processing core operable to process a first instruction set;
a second processing core operable to process a second instruction set different from the first instruction set;
a plurality of peripheral devices;
a memory; and
a switching circuit configured to couple the memory and the plurality of peripheral devices with either the first processing core or the second processing core depending on a configuration setting of the integrated circuit device.

2. The integrated circuit device according to claim 1, wherein the configuration setting is determined at power-up by decoding a fuse setting.

3. The integrated circuit device according to claim 1, wherein the configuration setting is included in object code to be executed by a specified one of the first processing core and the second processing core.

4. The integrated circuit device according to claim 1, wherein the configuration setting is determined at power-up by determining a logic state at an external pin of the integrated circuit device.

5. The integrated circuit device according to claim 1, wherein the configuration setting is fixed during manufacture of the integrated circuit device by a set internal fuse.

6. The integrated circuit device according to claim 1, wherein the configuration setting is derived from a type of architecture of either the first processing core or the second processing core.

7. The integrated circuit device according to claim 1, wherein:
the first processing core and the second processing core are each implemented in different respective architectures;
the integrated circuit device includes object code to be executed;
the object code is executable by the first processing core;
the object code is unexecutable by the second processing core; and
the configuration setting is based upon differences in respective architectures of the first processing core and the second processing core.

8. At least one non-transitory computer-readable medium comprising instructions, the instructions, when loaded and executed by an integrated circuit device, cause the integrated circuit device to:
process a first instruction set using a first processing core;
process a second instruction set using a second processing core, the second instruction set different from the first instruction set; and
selectively couple a memory and a plurality of peripheral devices with either the first processing core or the second processing core depending on a configuration setting of the integrated circuit device.

9. The medium according to claim 8, wherein the configuration setting is determined at power-up by decoding a fuse setting.

10. The medium according to claim 8, wherein the configuration setting is included in object code to be executed by a specified one of the first processing core and the second processing core.

11. The medium according to claim 8, wherein the configuration setting is determined at power-up by determining a logic state at an external pin of the integrated circuit device.

12. The medium according to claim 8, wherein the configuration setting is fixed during manufacture of the integrated circuit device by a set internal fuse.

13. The medium according to claim 8, wherein the configuration setting is derived from a type of architecture of either the first processing core or the second processing core.

14. The medium according to claim 8, wherein:
the first processing core and the second processing core are each implemented in different respective architectures;
the integrated circuit device includes object code to be executed;
the object code is executable by the first processing core;
the object code is unexecutable by the second processing core; and
the configuration setting is based upon differences in respective architectures of the first processing core and the second processing core.

15. A method, comprising:
processing a first instruction set using a first processing core;
processing a second instruction set using a second processing core, the second instruction set different from the first instruction set; and
selectively coupling a memory and a plurality of peripheral devices with either the first processing core or the second processing core depending on a configuration setting of the integrated circuit device.

16. The method according to claim 15, wherein the configuration setting is determined at power-up by decoding a fuse setting.

17. The method according to claim 15, wherein the configuration setting is included in object code to be executed by a specified one of the first processing core and the second processing core.

18. The method according to claim 15, wherein the configuration setting is determined at power-up by determining a logic state at an external pin of the integrated circuit device.

19. The method according to claim 15, wherein the configuration setting is derived from a type of architecture of either the first processing core or the second processing core.

20. The method according to claim 15, wherein:
the first processing core and the second processing core are each implemented in different respective architectures;
the integrated circuit device includes object code to be executed;
the object code is executable by the first processing core;
the object code is unexecutable by the second processing core; and
the configuration setting is based upon differences in respective architectures of the first processing core and the second processing core.
